(19) United States
(12) Patent Application Publication
(10) Pub. No.: US 2014/0302278 A1
(43) Pub. Date: Oct. 9, 2014

(54) COMPONENTS WITH DOUBLE SIDED COOLING FEATURES AND METHODS OF MANUFACTURE

(71) Applicant: GENERAL ELECTRIC COMPANY, Schenectady, NY (US)

(72) Inventor: Ronald Scott Bunker, Waterford, NY (US)

(73) Assignee: General Electric Company, Schenectady, NY (US)

(21) Appl. No.: 13/859,437

(22) Filed: Apr. 9, 2013

(51) Int. Cl. F01D 25/12; B05D 3/12; B05D 3/14; B05D 3/00; B05D 3/06

(52) U.S. Cl. CPC F01D 25/12; B05D 3/002; B05D 3/06; B05D 3/14; B05D 3/12
USPC 428/137; 427/299; 427/331; 427/554; 427/540; 427/560

(57) ABSTRACT

A manufacturing method includes providing a substrate and forming one or more grooves into an outer surface of the substrate or into a coating layer disposed on the outer surface of the substrate and forming one or more grooves into an inner surface of the substrate or into a coating layer disposed on the inner surface of the substrate, to define one or more cooling grooves on the inner surface of the substrate. The method further includes applying a structural coating over at least one of a portion of the outer surface of the substrate or a portion of the coating disposed on the outer surface of the substrate to define one or more cooling channels on the outer surface of the substrate. A component is disclosed fabricated according to the method.

### BACKGROUND

The disclosure relates generally to gas turbine engines, and, more specifically, to micro-channel cooling therein.

In a gas turbine engine, air is pressurized in a compressor and mixed with fuel in a combustor for generating hot combustion gases. Energy is extracted from the gases in a high pressure turbine (HPT), which powers the compressor, and in a low pressure turbine (LPT), which powers a fan in a turbofan aircraft engine application, or powers an external shaft for marine and industrial applications.

Engine efficiency increases with temperature of combustion gases. However, the combustion gases heat the various components along their flowpath, which in turn requires cooling thereof to achieve an acceptably long engine lifetime. Typically, the hot gas path components are cooled by bleeding air from the compressor. This cooling process reduces engine efficiency, as the bled air is not used in the combustion process.

Gas turbine engine cooling art is mature and includes numerous patents for various aspects of cooling circuits and features in the various hot gas path components. For example, the combustor includes radially outer and inner liners, which require cooling during operation. Turbine nozzles include hollow vanes supported between outer and inner bands, which also require cooling. Turbine rotor blades are hollow and typically include cooling circuits therein, with the blades being surrounded by turbine shrouds, which also require cooling. The hot combustion gases are discharged through an exhaust which may also be lined and suitably cooled.

In all of these exemplary gas turbine engine components, thin walls of high strength superalloy metals are typically used to reduce component weight and minimize the need for cooling thereof. Various cooling circuits and features are tailored for these individual components in their corresponding environments in the engine. For example, a series of internal cooling passages, or serpentines, may be formed in a hot gas path component. A cooling fluid may be provided to the serpentines from a plenum, and the cooling fluid may flow through the passages, cooling the hot gas path component substrate and any associated coatings. However, this cooling strategy typically results in comparatively inefficient heat transfer and non-uniform component temperature profiles.

Employing micro-channel cooling techniques has the potential to significantly reduce cooling requirements. Typically, micro-channel cooling places the cooling as close as possible to the heat flux source, and more specifically places the cooling channels on the exterior or hot side, thus reducing the temperature difference between the hot side and cold side of the load bearing substrate material for a given heat transfer rate. Many components, however, may require even high levels of overall cooling effectiveness or flexibility than can be provided with placing micro-channels on solely the exterior or hot side.

It would therefore be desirable to provide a method for forming cooling channels in hot gas path components that provide for increased cooling capabilities, and effectiveness and flexibility, while reducing fabrication time and techniques.

### BRIEF DESCRIPTION

One aspect of the present disclosure resides in a manufacturing method that includes providing a substrate with an inner surface, an outer surface and at least one interior space. One or more grooves are formed into the outer surface of the substrate or into a coating layer disposed on the outer surface of the substrate, wherein each groove extends at least partially along the outer surface. One or more grooves are formed into the inner surface of the substrate or into a coating layer disposed on the inner surface of the substrate, wherein each groove extends at least partially along the inner surface to define one or more cooling grooves on the inner surface of the substrate. A structural coating is applied over at least one of a portion of the outer surface of the substrate or a portion of the coating disposed on the outer surface of the substrate to define one or more channels on the outer surface of the substrate.

Another aspect of the present disclosure resides in a manufacturing method that includes providing a substrate with an inner surface, an outer surface and at least one interior space. One or more grooves are formed into the outer surface of the substrate or into a coating layer disposed on the outer surface of the substrate, wherein each groove extends at least partially along the outer surface. In addition, one or more grooves are formed into the inner surface of the substrate or into a coating layer disposed on the inner surface of the substrate, wherein each groove extends at least partially along the inner surface. At least a portion of one of the outer surface of the substrate or the coating disposed on the outer surface of the substrate is processed to plastically deform and facet one of the outer surface of the substrate or an outer surface of the coating at least in a vicinity of a top of a respective groove, such that a gap across the top of the groove is reduced. A structural coating is applied over one of at least a portion of the outer surface of the substrate or at least a portion of the coating layer disposed on the outer surface of the substrate. One or more cooling channels are defined one of into the inner surface of the substrate or into a coating layer disposed on the inner surface of the substrate and one or more cooling channels or cooling grooves are defined one of into the outer surface of the substrate or into a coating layer disposed on the outer surface of the substrate for cooling a component.

Yet another aspect of the present disclosure resides in a component that includes a substrate comprising an outer surface and an inner surface, wherein the inner surface defines at least one interior space. One or more grooves are formed into the outer surface of the substrate or into a coating layer disposed on the outer surface of the substrate. Each groove extends at least partially along the outer surface and has a base and an opening. In addition, one or more grooves are formed into the inner surface of the substrate or into a coating layer disposed on the inner surface of the substrate. Each groove extends at least partially along the inner surface to define one or more cooling grooves on an inner surface of the substrate and has a base and an opening. A structural coating is disposed over one of at least a portion of the outer surface of the substrate or the coating disposed on the outer surface of the substrate to define one or more cooling channels on the outer surface of the substrate.

Various refinements of the features noted above exist in relation to the various aspects of the present disclosure. Further features may also be incorporated in these various aspects as well. These refinements and additional features may exist individually or in any combination. For instance, various features discussed below in relation to one or more of the illustrated embodiments may be incorporated into any of the above-described aspects of the present disclosure alone or in any combination. Again, the brief summary presented above is intended only to familiarize the reader with certain aspects and contexts of the present disclosure without limitation to the claimed subject matter.

### DRAWINGS

These and other features, aspects, and advantages of the present disclosure will become better understood when the following detailed description is read with reference to the accompanying drawings in which like characters represent like parts throughout the drawings, wherein:

FIG. 1 is a schematic illustration of a gas turbine system in accordance with one or more embodiments shown or described herein;

FIG. 2 is a schematic cross-section of an example airfoil configuration with double sided cooling, in accordance with one or more embodiments shown or described herein;

FIG. 3 is a schematic cross-section of an example combustor configuration with double sided cooling, in accordance with one or more embodiments shown or described herein;

FIG. 4 schematically depicts a step in a method of manufacture of an example hot gas path component with double sided cooling, in accordance with one or more embodiments shown or described herein;

FIG. 5 schematically depicts a step in a method of manufacture of an example hot gas path component with double sided cooling, in accordance with one or more embodiments shown or described herein;

FIG. 6 schematically depicts a step in a method of manufacture of an example hot gas path component with double sided cooling, in accordance with one or more embodiments shown or described herein;

FIG. 7 is a cross-sectional view of the double sided micro-channel cooled hot gas path component fabricated according to the method of FIGS. 5-7 and in accordance with one or more embodiments shown or described herein;

FIG. 8 schematically depicts an alternate embodiment of a step in a method of manufacture of an example hot gas path component with double sided cooling, in accordance with one or more embodiments shown or described herein;

FIG. 9 schematically depicts an alternate embodiment of a step in a method of manufacture of an example hot gas path component with double sided cooling, in accordance with one or more embodiments shown or described herein;

FIG. 10 schematically depicts an alternate embodiment of a step in a method of manufacture of an example hot gas path component with double sided cooling, in accordance with one or more embodiments shown or described herein;

FIG. 11A schematically depicts an alternate embodiment of a step in a method of manufacture of an example hot gas path component with double sided cooling, in accordance with one or more embodiments shown or described herein;

FIG. 11B schematically depicts an alternate embodiment of a step in a method of manufacture of an example hot gas path component with double sided cooling, in accordance with one or more embodiments shown or described herein;

FIG. 12 schematically depicts an alternate embodiment of a step in a method of manufacture of an example hot gas path component with double sided cooling, in accordance with one or more embodiments shown or described herein;

FIG. 13 schematically depicts an alternate embodiment of a step in a method of manufacture of an example hot gas path component with double sided cooling, in accordance with one or more embodiments shown or described herein;

FIG. 14 is a cross-sectional view of the double sided micro-channel cooled hot gas path component fabricated according to the method of FIGS. 9-14 and in accordance with one or more embodiments shown or described herein; and

FIG. 15 is a flow chart depicting one implementation of a method of making a hot gas path component including double sided micro-cooling in accordance with one or more embodiments shown or described herein.

### DETAILED DESCRIPTION

The terms “first,” “second,” and the like, herein do not denote any order, quantity, or importance, but rather are used to distinguish one element from another. The terms “a” and “an” herein do not denote a limitation of quantity, but rather denote the presence of at least one of the referenced items. The modifier “about” used in connection with a quantity is inclusive of the stated value, and has the meaning dictated by context, (e.g., includes the degree of error associated with measurement of the particular quantity). In addition, the term “combination” is inclusive of blends, mixtures, alloys, reaction products, and the like.

Moreover, in this specification, the suffix “(s)” is usually intended to include both the singular and the plural of the term that it modifies, thereby including one or more of that term (e.g., “the passage hole” may include one or more passage holes, unless otherwise specified). Reference throughout the specification to “one embodiment,” “another embodiment,” “an embodiment,” and so forth, means that a particular element (e.g., feature, structure, and/or characteristic) described in connection with the embodiment is included in at least one embodiment described herein, and may or may not be present in other embodiments. Similarly, reference to “a particular configuration” means that a particular element (e.g., feature, structure, and/or characteristic) described in connection with the configuration is included in at least one configuration described herein, and may or may not be present in other configurations. In addition, it is to be understood that the described inventive features may be combined in any suitable manner in the various embodiments and configurations.

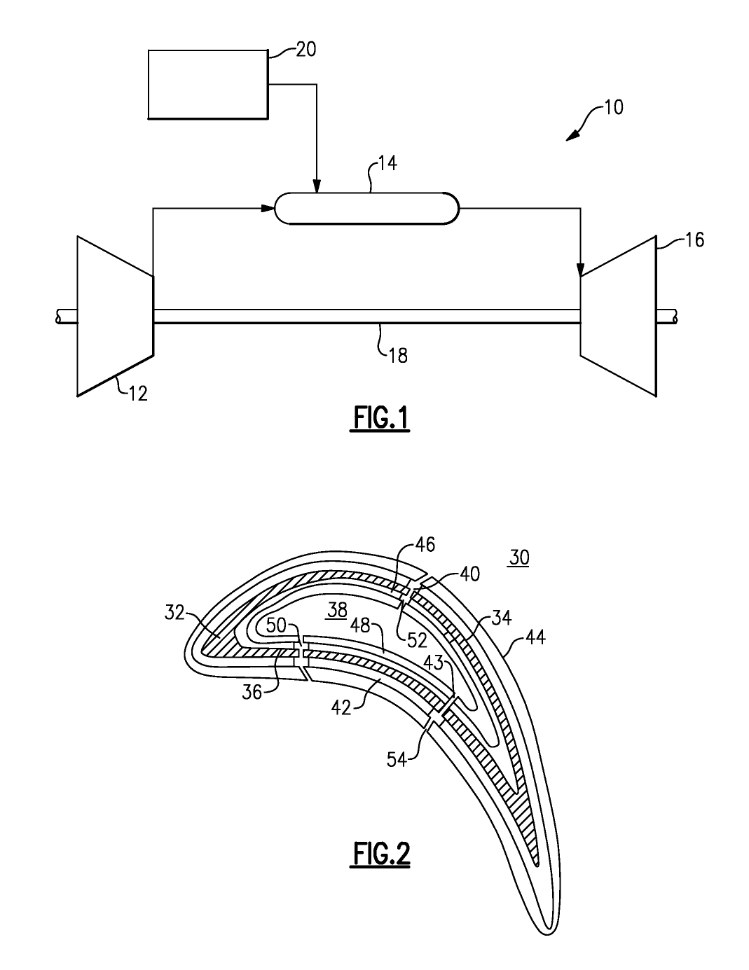

FIG. 1 is a schematic diagram of a gas turbine system 10. The system 10 may include one or more compressors 12, combustors 14, turbines 16, and fuel nozzles 20. The compressor 12 and turbine 16 may be coupled by one or more shafts 18. The shaft 18 may be a single shaft or multiple shaft segments coupled together to form shaft 18.

The gas turbine system 10 may include a number of hot gas path components. A hot gas path component is any component of the system 10 that is at least partially exposed to a flow of high temperature gas through the system 10. For example, bucket assemblies (also known as blades or blade assemblies), nozzle assemblies (also known as vanes or vane assemblies), shroud assemblies, transition pieces, retaining rings, and turbine exhaust components are all hot gas path components. However, it should be understood that the hot gas path component of the present disclosure is not limited to the above examples, but may be any component that is at least partially exposed to a flow of high temperature gas. Further, it should be understood that the hot gas path component of the present disclosure is not limited to components in gas turbine systems 10, but may be any piece of machinery or component thereof that may be exposed to high temperature flows.

When a hot gas path component is exposed to a hot gas flow, the hot gas path component is heated by the hot gas flow and may reach a temperature at which the hot gas path component is substantially degraded or fails. Thus, in order to allow system 10 to operate with hot gas flow at a high temperature, as required to achieve the desired efficiency, performance and/or life of the system 10, a cooling system for the hot gas path component is needed.

In general, the cooling system of the present disclosure includes a series of cooling grooves, small channels, or micro-channels, defined in one of a substrate and/or a coating layer on a first side and opposed second side of the hot gas path component. The hot gas path component may include one or more grooves formed either in an outer and inner surface of the substrate or in the coating layer disposed on the inner and outer surface of the substrate. An additional coating layer may be disposed on one of the substrate of the coating layer to bridge there over the one or more grooves, and form the micro-channels, also referred to herein as cooling channels. For industrial sized power generating turbine components, “small” or “micro” channel dimensions would encompass approximate depths and widths in the range of 0.25 mm to 1.5 mm, while for aviation sized turbine components channel dimensions would encompass approximate depths and widths in the range of 0.1 mm to 0.5 mm. A cooling fluid may be provided to the channels from a plenum, and the cooling fluid may flow through the channels and/or cooling grooves, cooling the hot gas path component.

Referring now to FIG. 2, illustrated is an example of a hot gas component 30 having an airfoil configuration. As indicated, the component 30 comprises a substrate 32 having an outer surface 34 and an inner surface 36. The inner surface 36 of the substrate 32 defines at least one hollow, interior space 38. In an alternate embodiment, in lieu of a hollow interior space 38, the hot gas component 30 may include a supply cavity. In the illustrated example, a coating 42 is disposed over at least a portion of the outer surface 34 of the substrate 32 and having a plurality of grooves formed therein. In addition, a structural coating 44 is disposed over the coating 42 to seal the grooves and define one or more cooling channels 40. In addition, a coating 46 is disposed over at least a portion of the inner surface 36 of the substrate 32. Defined within the coating 46 are one or more grooves 50. In the illustrated embodiment, a structural coating 48 is disposed thereover the coating 46 to seal the grooves 50 and define one or more cooling channels 52. In an alternate embodiment, a structural coating is not disposed on coating 46 and the grooves 50 defined therein provide for enhanced thermal cooling. In the illustrated embodiment, each of the cooling channels 40 and 52 extend at least partially within the coatings 42, 46 and in fluidic communication with the at least one hollow, interior space 38 via one or more cooling supply holes 43. The cooling supply holes 43 are configured as discrete openings and do not run the length of the respective cooling channels 40, 52. One or more coolant exit features 54 may be defined in the structural coating 48 to allow for the exit of hot fluid flow.

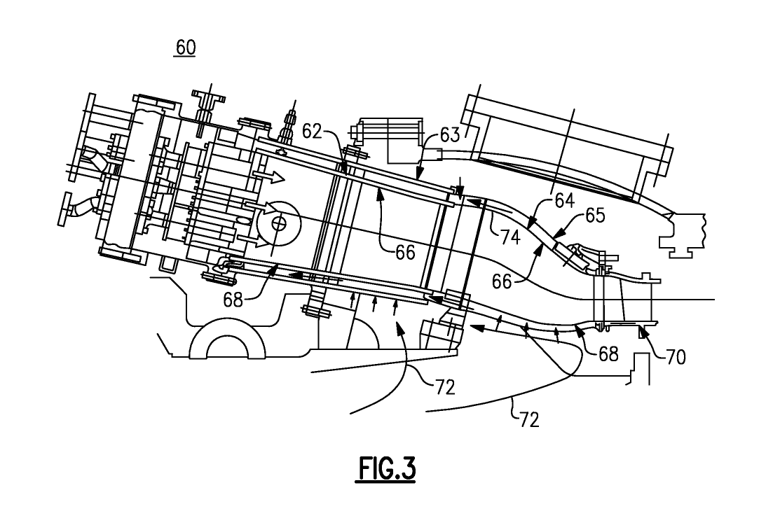

Referring now to FIG. 3, illustrated is a schematic cross-section of an example combustor engine including one or more double sided cooled components, in accordance with one or more embodiments shown or described herein. More particularly, illustrated is an example of a combustor engine 60 including a plurality of hot gas components, and more specifically, including a combustor liner 62 and combustor transition component 64. In this particular embodiment, the combustor liner 62 includes a liner flow sleeve 63 and the combustor transition component 64 includes a surrounding flow sleeve 65. The combustor liner 62 and combustor transition component 64 are components that have readily accessible coolant-side 68 and hot gas side 66 where the processing of micro channels and coatings can be accomplished on both sides to achieve double-sided cooling of the component. In the illustrated components 60 and 62, double-sided micro-cooling delivers advantages of tailored cooling to the cool side as well as the hot side. FIG. 3 further illustrates a downstream turbine nozzle 70 and a flow of compressor discharge air, illustrated by arrows 72.

As described below, the method disclosed herein includes deposition and machining techniques to create a three-dimensional finished component, and more particularly a hot gas path component that may be configured as an airfoil, such as airfoil 30 of FIG. 2, a combustor liner, such as combustor liner 62 of FIG. 3, a combustor transition component, such as combustor transition component 64 of FIG. 3, or other hot gas path component, such as dome plates, splash plates or any other hot gas path components including a readily accessible coolant-side and hot gas side and where the processing of micro-cooling features and coatings can be accomplished on both sides. The method may result in a component that includes near transpiration cooling without the necessity of using porous materials of diminished strength. The cooling channels may be arbitrary, or specifically targeted for location and size, and as such flexible in design. Furthermore, in an embodiment, re-entrant shaped cooling channels, typically utilized to minimize deposition of a coating material within the channel structure, may not be required, resulting in a decrease in machining time and relaxation of design tolerances.

As previously indicated, exemplary embodiments fabricated according to the method disclosed herein are the fabrication of a gas turbine airfoil, combustor engine liner or transition component including an interior hollow passageway in fluidic communication with a plurality of cooling features formed on an interior and exterior side of the component, so as to provide double-sided cooling.

A method of manufacturing a component 80, generally similar to components 30, 62 or 64, is described with reference to FIGS. 4-15. It should be understood that embodiments of the manufacturing method are provided for purposes of disclosure, and that further combinations of the steps provided herein are anticipated by this disclosure. Referring now to FIG. 4, the manufacturing method comprises forming one or more grooves 88 extending a depth into a substrate 82. In an alternate embodiment, only a portion of the grooves 88 extend a depth into the substrate 82. As shown in FIG. 4, the substrate 82 includes an inner surface 84 that defines the at least one hollow, interior space 90 and an outer surface 86. For the example configuration shown in FIGS. 4-7, the one or more grooves 88 are substantially rectangular in cross-section. Although shown as having straight walls, the one or more grooves 88 may have any wall configuration, for example, they may be straight or curved. In an embodiment, and for the example arrangements shown in FIGS. 4-7, upon completion, each of the one or more grooves 88 includes substantially parallel sidewalls 92, a base 94 and an opening 96. In an alternate embodiment, upon completion, each of the one or more grooves may narrow at a respective opening thereof, such that each groove comprises a re-entrant shaped groove (described presently). The formation of re-entrant-shaped grooves is described in commonly assigned, U.S. Pat. No. 8,387,245, Ronald Scott Bunker et al., “Components with re-entrant shaped cooling channels and methods of manufacture.”

As previously described with regard to FIG. 2, provided is the substrate 82, generally similar to substrate 32 of FIG. 2. In this particular embodiment, at least a portion of the one or more grooves 88 are initially formed at a depth into both the inner surface 84 and the outer surface 86 of the substrate 82. More particularly, as best illustrated in FIG. 4, the method includes a subtractive process into the inner surface 84 and the outer surface 86 of the substrate 82 so as to form at least a portion of the one or more grooves 88 extending thereunto. Alternatively, the substrate 82 may be initially cast to include at least a portion of the one or more grooves 88 formed therein. The one or more grooves 88 defined in the inner surface 84 of the substrate 82 extend along the inner surface 84 and the one or more grooves 88 defined in the outer surface 86 of the substrate 82 extend along the outer surface 86. In an embodiment, the one or more grooves 88 may be formed in one or more vertical and horizontal directions or in a pattern. Patterns may be formed in a grid-like manner or in any arbitrary geometry, including curved grooves, as long as dimensional requirements are maintained.

In an embodiment, the substrate 82 is cast prior to forming the one or more grooves 88. As discussed in U.S. Pat. No. 5,626,462, Melvin R. Jackson et al., “Double-wall airfoil,” which is incorporated herein in its entirety, substrate 82 may be formed from any suitable material. Depending on the intended application for the hot gas component 80, this could include Ni-base, Co-base and Fe-base superalloys. The Ni-base superalloys may be those containing both γ and γ′ phases, particularly those Ni-base superalloys containing both γ and γ′ phases wherein the γ′ phase occupies at least 40% by volume of the superalloy. Such alloys are known to be advantageous because of a combination of desirable properties including high temperature strength and high temperature creep resistance. The substrate material may also comprise a NiAl intermetallic alloy, as these alloys are also known to possess a combination of superior properties including high temperature strength and high temperature creep resistance that are advantageous for use in turbine engine applications used for aircraft. In the case of Nb-base alloys, coated Nb-base alloys having superior oxidation resistance will be preferred, particularly those alloys comprising Nb-(27-40)Ti-(4.5-10.5)Al-(4.5-7.9)Cr-(1.5-5.5)Hf-(0-6)V, where the composition ranges are in atom percent. The substrate material may also comprise a Nb-base alloy that contains at least one secondary phase, such as a Nb-containing intermetallic compound comprising a silicide, carbide or boride. Such alloys are composites of a ductile phase (i.e., the Nb-base alloy) and a strengthening phase (i.e., a Nb-containing intermetallic compound). For other arrangements, the substrate material comprises a molybdenum based alloy, such as alloys based on molybdenum (solid solution) with Mo₅SiB₂ and Mo₃Si second phases. For other configurations, the substrate material comprises a ceramic matrix composite, such as a silicon carbide (SiC) matrix reinforced with SiC fibers. For other configurations the substrate material comprises a TiAl-based intermetallic compound.

In the illustrated embodiment, the one or more grooves 88 may be formed using a variety of techniques. Example techniques for forming the groove(s) 88 into the substrate 82 include abrasive liquid jet, plunge electrochemical machining (ECM), electric discharge machining (EDM) with a spinning electrode (milling EDM), and laser machining Example laser machining techniques are described in commonly assigned, U.S. patent application Ser. No. 12/697,005, “Process and system for forming shaped air holes” filed Jan. 29, 2010, which is incorporated by reference herein in its entirety. Example EDM techniques are described in commonly assigned U.S. patent application Ser. No. 12/790,675, “Articles which include chevron film cooling holes, and related processes,” filed May 28, 2010, which is incorporated by reference herein in its entirety.

For particular processes, a portion of each of the grooves 88 is formed using an abrasive liquid jet 98 (FIG. 4). Example water jet drilling processes and systems are provided in commonly assigned U.S. patent application Ser. No. 12/790,675, “Articles which include chevron film cooling holes, and related processes,” filed May 28, 2010, which is incorporated by reference herein in its entirety. As explained in U.S. patent application Ser. No. 12/790,675, the water jet process typically utilizes a high-velocity stream of abrasive particles (e.g., abrasive “grit”), suspended in a stream of high pressure water. The pressure of the water may vary considerably, but is often in the range of about 35-620 MPa. A number of abrasive materials can be used, such as garnet, aluminum oxide, silicon carbide, and glass beads. Beneficially, the capability of abrasive liquid jet machining techniques facilitates the removal of material in stages to varying depths, with control of the shaping. This allows the portion of each of the one or more grooves 88 formed into the inner surface 84 and outer surface 86 of the substrate 82 to be drilled either having substantially parallel sides, or angled, so as to form re-entrant shape grooves, as previously indicated.

As explained in U.S. patent application Ser. No. 12/790,675, the water jet system may include a multi-axis computer numerically controlled (CNC) unit. The CNC systems themselves are known in the art, and described, for example, in U.S. Patent Publication 1005/0013926 (S. Rutkowski et al), which is incorporated herein by reference. CNC systems allow movement of the cutting tool along a number of X, Y, and Z axes, as well as rotational axes.

In an embodiment defining the one or more grooves 88 having substantially parallel sides, each of the portions of the one or more grooves 88 formed into the inner surface 84 and the outer surface 86 of the substrate 82 to a prescribed depth may be formed by directing the abrasive liquid jet at a substantially normal angle relevant to the local surfaces 84, 86 of the substrate 82. In an alternate embodiment, the portion of the grooves formed into the surfaces of the substrate may include defining a re-entrant shaped grooves, wherein each of the portions of the one or more grooves formed into the inner surface and the outer surface of the substrate to a prescribed depth may be formed by directing the abrasive liquid jet at a lateral angle relative to the surface of the substrate in a first pass of the abrasive liquid jet and then making a subsequent pass at an angle substantially opposite to that of the lateral angle, such that each groove begins to narrow toward an opening of the groove. Typically, multiple passes will be performed to achieve the desired depth and width for the groove. This technique is described in commonly assigned, U.S. patent application Ser. No. 12/943,624, Bunker et al., “Components with re-entrant shaped cooling channels and methods of manufacture,” which is incorporated by reference herein in its entirety. In addition, the step of forming the one or more re-entrant shaped grooves may further comprise performing an additional pass where the abrasive liquid jet is directed toward the base of the groove at one or more angles between the lateral angle and a substantially opposite angle, such that material is removed from the base of the groove.

Referring now to FIG. 5, the manufacturing method further includes disposing a structural coating 102 over at least the outer surface 86 of the substrate 82, to further define the one or more grooves 88, and ultimately form one or more cooling channels 104 on the outer surface for cooling the component 80. More particularly, subsequent to formation of a portion of the one or more grooves 88 into the outer surface 86 of the substrate 82, the structural coating 102 is applied in a manner so as to substantially seal the one or more grooves 88. In an embodiment, as illustrated in FIG. 5, depending upon access to the inner surface 84 of the substrate 82, a structural coating 102 may additionally be applied to the inner surface 84 of the substrate, in a manner so as to substantially seal the one or more grooves 88 formed in the inner surface 84 of the substrate 82, and define one or more cooling channels 104 on the inner surface 84 for cooling the component 80. It should be understood that the one or more cooling channels 104 on the inner surface 84 and outer surface 86 of the substrate 82 may not be identical in geometry, nor precisely located opposite each other. In an embodiment, where access to the inner surface 84 of the substrate 82 is limited, the grooves 88 formed therein the inner surface 84 may remain having the opening 96, in an open state, and provide increased thermal enhancement to the component 80.

For the arrangement shown in FIGS. 4-7, and in particular FIG. 5, the coating 102 is deposited in a manner so as to further define the one or more grooves 88. In an embodiment, the coating material 102 is fabricated, such as by deposition, having a thickness of approximately 0.030″, although it should be understood that the thickness of the coating 42 is design dependent and dictated by desired resulting cooling feature size. In an embodiment, coating 102 substantially seals the openings 96 of the one or more grooves 88. As previously indicated, the distance across the opening 96, may vary based on the specific application. In an embodiment, the distance across the opening 96 of each of the one or more grooves 88 is in a range of about 0-15 mil (0.0-0.4 mm) Beneficially, this facilitates applying the coating 102 without the use of a sacrificial filler (not shown). In an embodiment, the substrate 82 may including treating, such as through peening (described presently), to further narrow the opening 96 and to facilitate applying the coating 102 without the use of a sacrificial filler.

In addition, a plurality of coolant supply holes 100 may be formed into the substrate 82 and coating 102 and in communication with each of the one or more grooves 88 as a straight hole of constant cross section, a shaped hole (elliptical etc.), or a converging or diverging holes. In an embodiment, the one or more coolant supply holes 100 are formed through the base 94 of a respective one of the grooves 88 formed on the outer surface 86 to connect the respective groove 88 in fluid communication with the respective hollow interior space 90. It should be noted that the coolant supply holes 100 are holes and are thus not coextensive with the cooling channels 104 grooves 88. Example techniques for forming the coolant supply holes, also referred to as coolant access holes, are described in commonly assigned, U.S. patent application Ser. No. 13/210,697, Bunker et al., “Components with cooling channels and methods of manufacture,” which is incorporated by reference herein in its entirety.

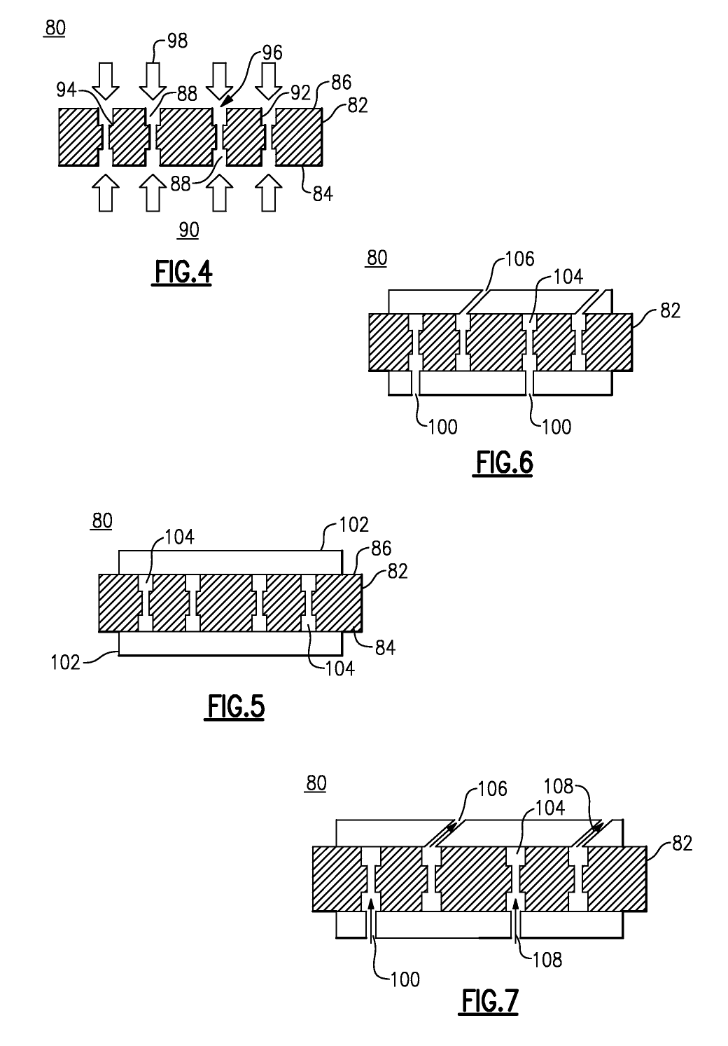

As best illustrated in FIGS. 6 and 7, one or more cooling exit features 106 are defined in the coating 102 disposed on the outer surface 86 of the substrate 82. In an embodiment, the cooling exit features 106 are formed by machining the coating 102. In an alternate embodiment, the cooling exit features 106 may be naturally formed during deposition of the coating 102 on the outer surface 86 of the substrate 82. The cooling exit features 106 connect the respective groove 88 in fluid communication with a means for cooling exit flow. It should be noted that in this particular embodiment, the one or more cooling exit features 106 are configured as holes and are not coextensive with the channels 104. It should be understood that the cooling exit features 106 can take on many alternate forms, including exit trenches that may connect the cooling exits of several cooling channels 104. Exit trenches are described in commonly assigned U.S. Patent Publication No. 2011/0145371, R. Bunker et al., “Components with Cooling Channels and Methods of Manufacture,” which is incorporated by reference herein in its entirety.

Referring now to FIG. 7, a complete component 80 including double-sided cooling features is illustrated. A flow 108 of coolant is indicated from the interior space 90 adjacent the interior surface 84 of the substrate to an exterior of the component 80 via the cooling exit features 106. The double sided micro-cooling channels provide increased cooling to component 80.

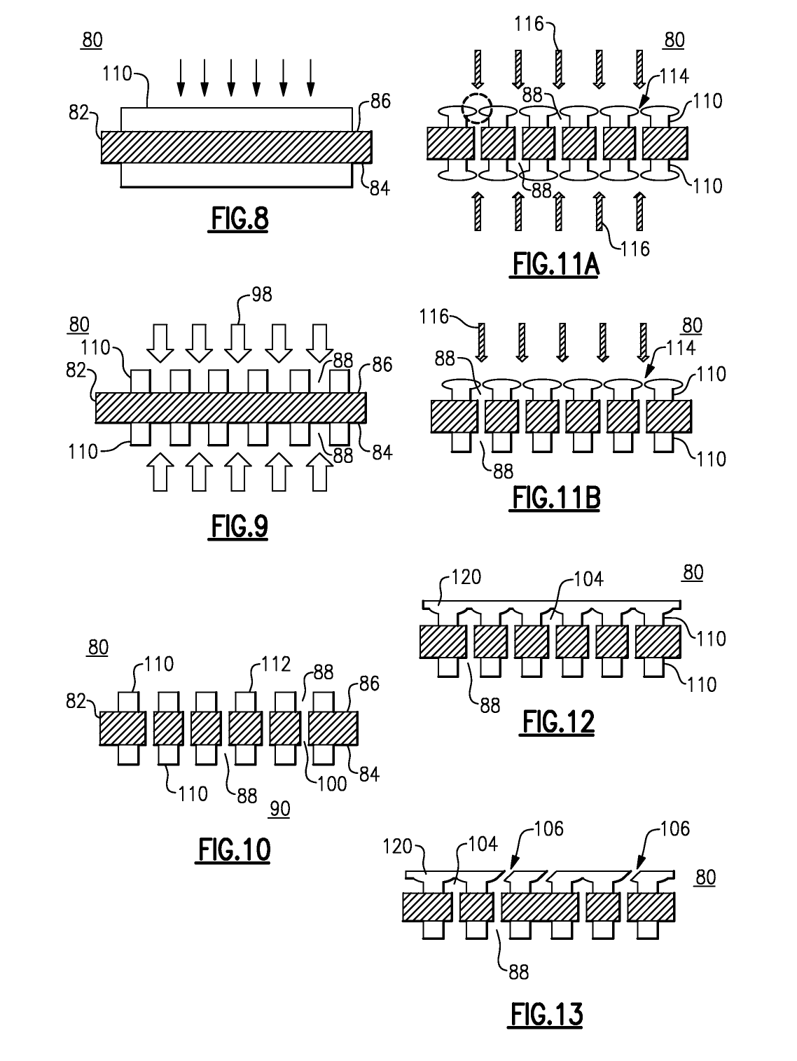

Referring now to FIGS. 8-14, an alternate method of manufacturing a component 80, generally similar to components 30, 62 or 64, is described. As indicated for example in FIG. 8, the manufacturing method includes depositing a coating 110 on the inner surface 84 and the outer surface 86 of the substrate 82. In an embodiment, subsequent to deposition, the coating material 110 is heat treated. In an embodiment, the coating material 110 is fabricated having a thickness of approximately 0.030″, although it should be understood that the thickness of the coating 110 is design dependent and dictated by desired resulting cooling feature size. As shown in FIG. 9, the manufacturing method includes forming one or more grooves 88 in the coating 110 deposited on the inner surface 84 and the outer surface 85 of the substrate 82. The one or more grooves 88 may be formed by machining, such as formed using an abrasive liquid jet 98, to selectively remove the coating 110 in one or more vertical and horizontal directions, without penetrating into the substrate 82. In an alternate embodiment, the one or more grooves 88 may be machined in the coating 110 and at least partially into the substrate 82 prior to further processing of the coating 110. Patterns may be formed in a grid-like manner or in any arbitrary geometry, including curved grooves, as long as dimensional requirements are maintained. As indicated, for example, in FIGS. 4 and 9, each groove 88 extends at least partially along the coating 110 deposited on the inner surface 84 of the substrate 82. In addition, each groove 88 extends at least partially along the coating 110 deposited on the outer surface 86 of the substrate 82.

As best illustrated in FIG. 10, one or more cooling supply holes 100 connect the one or more grooves 88 on an outer surface 86 of the substrate 82 to the respective interior spaces 90. As shown in FIG. 2, the substrate 82, generally similar to substrate 32, has at least one interior space 90, generally similar to interior space 38 of FIG. 2. It should be noted that the cooling supply holes 100, shown in FIG. 10, are discrete holes located in the cross-section shown and do not extend through the substrate 82 along the length of the one or more grooves 88. The cooling supply holes 100 may be machined anywhere and in any desired pattern connecting the one or more grooves 88 to the respective interior space 90. The cooling supply holes 100 may be formed at a normal angle relevant to the local surface, such as the inner surface 84 of the substrate 82, as best illustrated in FIG. 10 or in an alternate embodiment, at an acute angle to the local surface. In an embodiment the supply cooling holes 100 may be machined through any remaining applied coating features, and more particularly through at least a portion of the coating 110.

As previously indicated with regard to the method described in FIGS. 4-7, the substrate 82 is typically a cast structure, as discussed in U.S. Pat. No. 5,626,462, Melvin R. Jackson et al., “Double-wall airfoil,” which is incorporated herein in its entirety. The substrate 82 may be formed from any suitable material as previously described herein.

The coating 110 may be applied or deposited using a variety of techniques. For particular processes, the coating 110 may be deposited by performing ion plasma deposition (also known in the art as cathodic arc deposition). Example ion plasma deposition apparatus and method are provided in commonly assigned, U.S. Pat. No. 7,879,203, Weaver et al., “Method and Apparatus for Cathodic Arc Ion Plasma Deposition,” which is incorporated by reference herein in its entirety. Briefly, ion plasma deposition comprises placing a consumable cathode having a composition to produce the desired coating material within a vacuum chamber, providing the substrate within the vacuum environment, supplying a current to the cathode to form a cathodic arc upon a cathode surface resulting in arc-induced erosion of coating material from the cathode surface, and depositing the coating material from the cathode upon the inner surface 84 and the outer surface 86 of the substrate 82.

Non-limiting examples of a coating deposited using ion plasma deposition are described in U.S. Pat. No. 5,626,462. For certain hot gas path components, the coating comprises a nickel-based or cobalt-based alloy, and more particularly comprises a superalloy or a (Ni,Co)CrAlY alloy. Where the substrate material is a Ni-base superalloy containing both γ and γ′ phases, coating may comprise similar compositions of materials, as discussed in U.S. Pat. No. 5,626,462. Additionally, for superalloys the coating may comprise compositions based on the γ′-Ni₃Al family of alloys.

For other process configurations, the coating 110 is deposited by performing at least one of a thermal spray process and a cold spray process. For example, the thermal spray process may comprise combustion spraying or plasma spraying, the combustion spraying may comprise high velocity oxygen fuel spraying (HVOF) or high velocity air fuel spraying (HVAF), and the plasma spraying may comprise atmospheric (such as air or inert gas) plasma spray, or low pressure plasma spray (LPPS, which is also known as vacuum plasma spray or VPS). In one non-limiting example, a (Ni,Co)CrAlY coating is deposited by HVOF or HVAF. Other example techniques for depositing the coating 110 include, without limitation, sputtering, electron beam physical vapor deposition, entrapment plating, and electroplating.

The one or more grooves 88 may be configured having any of a number of different shapes. For the example configuration shown in FIGS. 7-14, the one or more grooves 88 are substantially rectangular in cross-section. Although shown as having straight walls, the one or more grooves 88 may have any wall configuration, for example, they may be straight or curved. In addition, as previously described, the one or more grooves 88 may be configured as re-entrant shaped grooves.

The one or more grooves 88 may be formed using a variety of techniques. Example techniques for forming the one or more grooves 88 in the coating 110 include an abrasive liquid jet, plunge electrochemical machining (ECM), electric discharge machining (EDM) with a spinning electrode (milling EDM), and/or laser machining. Example laser machining techniques are described in commonly assigned, U.S. Publication No. 2011/0185572, B. Wei et al., “Process and System for Forming Shaped Air Holes”, which is incorporated by reference herein in its entirety. Example EDM techniques are described in commonly assigned U.S. Patent Publication No. 2011/0293423, R. Bunker et al., “Articles Which Include Chevron Film Cooling Holes and Related Processes,” which is incorporated by reference herein in its entirety. For particular processes, the one or more grooves 88 and cooling supply holes 100 are formed using an abrasive liquid jet 98 (FIG. 9) as previously described.

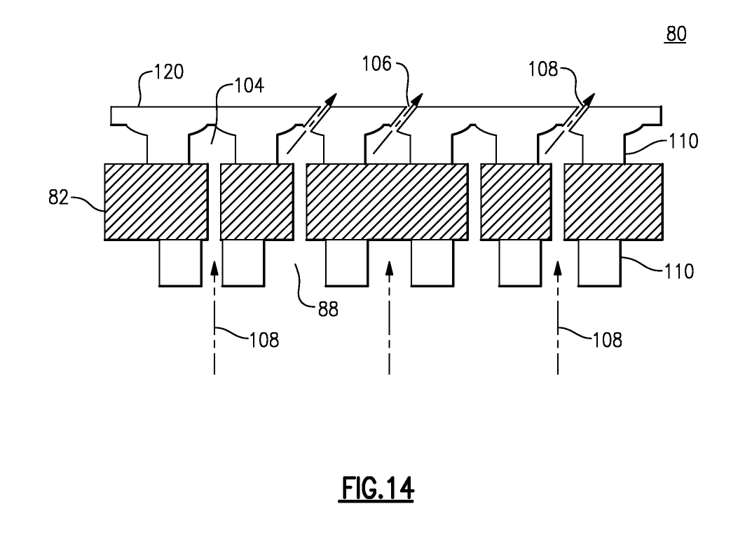

For the method depicted in FIGS. 8-14, the manufacturing method may further include processing at least a portion of a surface 112 of the coating 110 to plastically deform the coating 110 at least in a vicinity of a top of a respective groove 88. As best illustrated in FIG. 11A, this surface processing step may be performed on the coating 110 deposited on the inner surface 84 where accessible and the coating 110 deposited on the outer surface 86 of the substrate 82. As best illustrated in FIG. 11B, this surface processing step may be performed solely on the coating 110 deposited on outer surface 86 of the substrate 82, where the coating 110 deposited on the inner surface 84 of the substrate is not easily accessible. The resulting processed coating 110 is shown, for example, in FIGS. 11A and 11B, whereby a gap 114 present across the top of the groove 88 is reduced as a result of the processing. Thus, processing the surface 112 affects a permanent deformation of the coating material 110. Beneficially, by reducing the gap 114 across the top of the groove 88, the manufacturing method improves the ability of one or more additional deposited coatings to bridge the opening directly (that is, without the use of a sacrificial filler). In addition, by reducing the gap 114 across the top of the groove 88, the manufacturing method facilitates the use of a less stringent machining specification for the width across the top of the groove 88. Beneficially, by reducing this machining specification, the manufacturing method may reduce the machining cost for the channels.

As previously indicated, the manufacturing method may further optionally include preheating the substrate 82 prior to or during the deposition of the coating 110. Further, the manufacturing method may further optionally include heat treating (for example vacuum heat treating at 1100° C. for two hours) the component 80 after the coating 110 has been deposited and prior to processing the surface of the coating 110. Thus, the step of processing the surface 112 of the coating 110 can be pre- or post-heat treatment. These heat treating options may improve the adhesion of the coating 110 to the inner surface 84 and the outer surface 86 of the substrate 82 and/or increase the ductility of the coating 110, both facilitating the processing of the coated substrate 82 so as to plastically deform the coating 110 and reduce the gap 114 across the top of the groove 88. In addition, the manufacturing method may further optionally include performing one or more grit blast operations. For example, the substrate surface 82 may optionally be grit blast on an inner surface 84, and outer surface 86, or both inner and outer surfaces 84, 86 prior to applying the coating 110. In addition, the processed coating surface 112 may optionally be subjected to a grit blast, so as to improve the adherence of a subsequently deposited additional coating (described presently). Grit blast operations would typically be performed after heat treatment, rather than immediately prior to heat treatment.

Commonly assigned U.S. patent application Ser. No. 13/242,179, R. Bunker et al., “Components with Cooling Channels and Methods of Manufacture”, filed Sep. 23, 2011, applies similar processing to the substrate 82. However, by processing the coating 110, the above described method is advantageous, in that the coating 110 may be more ductile than the substrate 82 and therefore more amenable to plastic deformation. In addition, defects induced in the coating 82 by the deformation process will affect a lower mechanical debit of the coated component and may be healed more readily than those in the substrate 82 during subsequent heat treatment. The system having a coating 110 can therefore be deformed to a greater degree using the above-described method than can the uncoated substrate using the method of U.S. patent application Ser. No. 13/242,179. In addition, by limiting the deformation to the coating 110 only, this may also avoid recrystallization of the substrate 82 (relative to the method of U.S. patent application Ser. No. 13/242,179), leading to improved mechanical properties under cyclic loading.

As previously indicated, the processing of the surface 112 of coating 110 reduces the gap 114 in the coating 110 in the vicinity of the top of the groove 88. As used here, “reduces the gap” means that the gap width after processing is less than that before processing. For particular configurations, the processing may geometrically close the opening, where “geometrically closed” means the coating 110 is brought in close proximity with coating 110 from the opposing side of the groove opening substantially closing the gap 114. Thus, as used here, being geometrically closed is not equivalent to being metallurgically bonded. However, for certain process configurations, a metallurgical bond may in fact form. Beneficially, reducing the size of the gap 114, further improves the ability of one or more additional deposited coatings to bridge the opening directly.

The surface 112 of the coating 110 may be processed using one or more of a variety of techniques, including without limitation, shot peening the surface 112, water jet peening the surface 112, flapper peening the surface 112, gravity peening the surface 112, ultrasonic peening the surface 112, burnishing the surface 112, low-plasticity burnishing the surface 112, and laser shock peening the surface 112, to plastically deform the coating 110 (and possibly also a portion of the substrate 82) at least in the vicinity of the groove 88, such that the gap 114 across the top of the groove 88 is reduced. Processing of surfaces are described in commonly assigned U.S. patent application bearing Ser. No. 13/663,967, R. Bunker, “Components with Micro-Cooled Coating Layer and Methods of Manufacture,” which is incorporated by reference herein in its entirety.

For particular processes, the surface 112 of the coating 110 is processed by shot peening 116. For other processes, the surface 112 of the coating 110 may be processed by burnishing. A variety of burnishing techniques may be employed, depending on the material being surface treated and on the desired deformation. Non-limiting examples of burnishing techniques include plastically massaging the surface 112 of the coating 110, for example using rollers, pins, or balls, and low plasticity burnishing.

The gap 114 across the top of each of the one or more grooves 88 will vary based on the specific application. However, for certain configurations, the gap 114 across the top of each of the one or more grooves 88 is in a range of about 8-40 mil (0.2-1.0 mm) prior to processing the surface 112 of the coating 110, and the gap 114 across the top of each of the one or more grooves 88 is in a range of about 0-15 mil (0-0.4 mm) after processing the surface 112 of the coating 110. For particular configurations, the step of processing the surface 112 of the coating 110 deforms the coating surface 112, such as “mushrooms” the coating 110 so as to form “facets”, in the vicinity of each of the one or more grooves 88. As used herein, “faceting” should be understood to tilt the surface 112 in the vicinity of the groove 88 toward the groove 88, as indicated, for example, in the circled region in FIG. 11A.

As indicated, for example, in FIG. 12, the manufacturing method further includes disposing an additional coating 120 over at least a portion of the surface 112 of the coating 110 disposed on at least the outer surface 86 of the substrate 82 to provide bridging of the gap 114. It should be noted that this additional coating 120 may comprise one or more different coating layers. For example, the coating 120 may include a structural coating and/or optional additional coating layer(s), such as bond coatings, thermal barrier coatings (TBCs) and oxidation-resistant coatings. For particular configurations, the coating 120 comprises an outer structural coating layer. As indicated, for example, in FIG. 12, the substrate 82, the coating 110 and the coating 120 define each of the one or more cooling channels 104 on an outer surface 86 of the substrate 82 for cooling the component 80. As previously indicated in the method of FIGS. 4-7, in an embodiment, and depending upon access to the inner surface 84 of the substrate 82, a coating 120 may additionally be applied to the inner surface 84 of the substrate 82, in a manner so as to substantially seal the one or more grooves 88 formed in the inner surface 84 of the substrate 82, and define one or more cooling channels 104 on the inner surface 84 for cooling the component 80. In an embodiment, where access to the inner surface 84 of the substrate 82 is limited, the grooves 88 formed therein the coating 110 disposed on the inner surface 84 of the substrate 82 may remain in an open state, and provide serve as cooling grooves 88 for thermal enhancement to the component 80.

For particular configurations, the coatings 110, 120 have a combined thickness in the range of 0.1-2.0 millimeters, and more particularly, in the range of 0.2 to 1 millimeter, and still more particularly 0.2 to 0.5 millimeters for industrial components. For aviation components, this range is typically 0.1 to 0.25 millimeters. However, other thicknesses may be utilized depending on the requirements for a particular component 80.

The coating layer(s) 120 may be deposited using a variety of techniques. Example deposition techniques for forming coatings are provided above. In addition to structural coatings, bond coatings, TBCs and oxidation-resistant coatings may also be deposited using the above-noted techniques.

For certain configurations, it is desirable to employ multiple deposition techniques for depositing the coatings 110, 120. For example, the coating 110 may be deposited using an ion plasma deposition, and the subsequently deposited coating 120 may be deposited using other techniques, such as a combustion thermal spray process or a plasma spray process. Depending on the materials used, the use of different deposition techniques for the coating layers may provide benefits in properties, such as, but not restricted to: strain tolerance, strength, adhesion, and/or ductility.

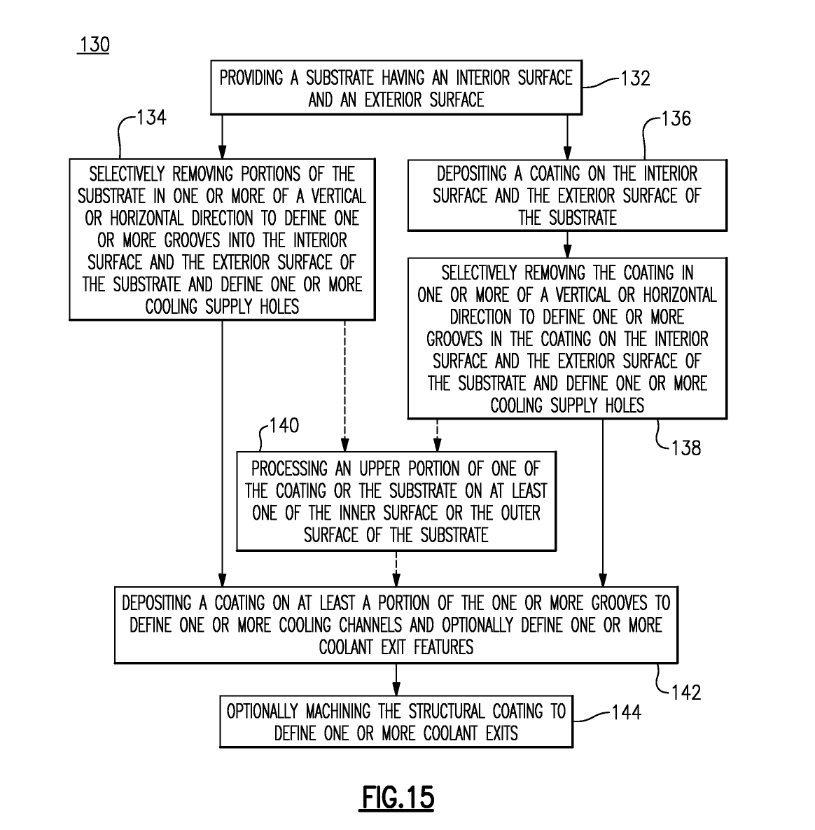

As indicated in FIG. 13, subsequent to the deposition of the coating 120 (and any other coatings such as ceramic coatings are applied), to complete the cooling pattern, one or more cooling exit features 106 may be machined through the coating 120 (and any subsequently deposited coatings) again in any locations and pattern desired as long as the one or more cooling exit features 106 provide fluid communication with the cooling pattern, and more particularly for the one or more cooling channels 104 formed on an outer surface 86 of the substrate 82 and grooves 88. The one or more cooling exit features 106 may again be normal to a local surface (as previously described) or angled, as best illustrated in FIG. 13, and include shaping etc. It should be understood that the cooling exit features 106 can take on many alternate forms, including exit trenches that may connect the cooling exits of several cooling channels. Exit trenches are described in commonly assigned U.S. Patent Publication No. 2011/0145371, R. Bunker et al., “Components with Cooling Channels and Methods of Manufacture,” which is incorporated by reference herein in its entirety.

Referring now to FIG. 14, a complete component 80 including double-sided cooling is illustrated. A flow 108 of coolant is indicated from the interior space 90 adjacent the interior surface 84 of the substrate to an exterior of the component 80 via the cooling exit features 106. The double sided micro-cooling channels provide increased cooling to component 80.

Referring now to FIG. 15, illustrated is a flow chart depicting implementations of a method 130 of making a component 80 including one or more cooling channels 104 formed into or on each of an inner surface 84 and an outer surface 86 of a substrate 82, according to one or more embodiments shown or described herein. The method 130 includes manufacturing the component 80 to ultimately include one or more cooling channels 104 by initially providing a substrate 82, in step 132. In a method, one or more grooves 88 are formed into an inner surface 84 and an outer surface 86 of the substrate 82, at step 134. More specifically, in an embodiment, step 134 includes selectively removing, such as by machining, portions of the substrate 82 in one or more of a vertical or horizontal direction to define one or more grooves 88 into the interior surface 84 and the exterior surface 86 of the substrate 82 and define one or more cooling supply holes 100 in fluidic communication therewith. The machining of patterns may be configured in a grid-like geometry or in any arbitrary geometry, including a curved geometry, as long as dimensional requirements are maintained.

In an alternate method, included is the depositing a coating 110 on an inner surface 84 and outer surface 86 of the substrate, at step 136. The coating 110 may optionally be heat treated prior to further processing steps. Next, at step 138, the coating 110 is machined to selectively remove the coating 110 in one or more vertical and horizontal directions, to define the one or more grooves 88, into the coating 110. Similar to the previously described step 134, the machining of patterns may be configured in a grid-like geometry or in any arbitrary geometry, including a curved geometry, as long as dimensional requirements are maintained. The one or more cooling supply holes 100 are additionally defined in the substrate 82, at step 138. The one or more cooling supply holes 100 are provided in fluidic communication with the interior space 90.

In an optional step 140, the inner 84 and/or outer surface 86 of the substrate 82, or the surface 112 of the coating 110 is next processed, such as in a shot peening process, to deform, and more in the instance of the coating 110, particularly, “mushroom” the surface 112 of the coating 110, and narrow the gap 114 of the one or more grooves 88. A coating 102 or 120 is next deposited, in a step 142, on at least a portion of the one or more grooves 88 to define one or more cooling channels 104 and optionally define one or more coolant exit features 106. Finally, in an optional step 144, and in particular, where coolant exit features 106 are not naturally formed in step 144, the one or more cooling exit features 106 are machined in the coating 102, 110 and/or 120 to define coolant exits. The one or more cooling exit features 106 are machined in any locations and pattern in the coatings 102 or 120 to provide fluid communication with the cooling pattern. After processing, provided is the component 80 including the interior space passageway 90, the one or more cooling supply holes 100 in fluidic communication with the interior passageway 90 and one or more cooling channels 104 formed into or on an outer surface 86 of the substrate and one or more cooling grooves 88 or cooling channels 104 formed into or on the inner surface 84 of the substrate and in fluidic communication with the one or more cooling supply holes 100.

Beneficially, the above described manufacturing methods provide for fabrication of a multi-layered engineered transpiration cooling component including increase cooling capabilities. More specifically, the component includes double-sided cooling to the component through the fabrication of one or more cooling channels formed on or into an outer surface of a substrate and one or more cooling channels or grooves formed on or into an inner surface of the substrate and provided thermal enhancement. The double-sided cooling capability may provide increased cooling to hot gas path components, such as turbine combustor liners, transition components, endwalls, platforms, shrouds, airfoils, and any other hot gas path component including a readily accessible coolant-side and hot gas side and where the processing of micro-cooling features and coatings can be accomplished on both sides.

Although only certain features of the disclosure have been illustrated and described herein, many modifications and changes will occur to those skilled in the art. It is, therefore, to be understood that the appended claims are intended to cover all such modifications and changes as fall within the true spirit of the disclosure.

1. A manufacturing method comprising:
providing a substrate with an inner surface, an outer surface and at least one interior space;
forming one or more grooves into the outer surface of the substrate or into a coating layer disposed on the outer surface of the substrate, wherein each groove extends at least partially along the outer surface;
forming one or more grooves into the inner surface of the substrate or into a coating layer disposed on the inner surface of the substrate, wherein each groove extends at least partially along the inner surface to define one or more cooling grooves on the inner surface of the substrate; and
applying a structural coating over at least one of a portion of the outer surface of the substrate or a portion of the coating disposed on the outer surface of the substrate to define one or more channels on the outer surface of the substrate.

2. The manufacturing method of claim 1, wherein each of the one or more grooves is formed using one or more of an abrasive liquid jet, plunge electrochemical machining (ECM), electric discharge machining (EDM) with a spinning electrode (milling EDM), casting and laser machining.

3. The manufacturing method of claim 1, wherein the step of forming one or more grooves into the outer surface and the inner surface of the substrate further comprises forming at least a portion of the one or more grooves into a portion of the substrate.

4. The manufacturing method of claim 1, further comprising processing at least a portion of at least one of an inner surface or an outer surface of the substrate or a surface of a coating disposed on at least one of the inner surface or outer surface of the substrate so as to plastically deform at least one of the substrate or the coating in a vicinity of the top of a respective groove, such that a gap across a top of the groove is reduced.

5. The manufacturing method of claim 4, wherein processing comprises performing one or more of shot peening the surface, water jet peening the surface, flapper peening the surface, gravity peening the surface, ultrasonic peening the surface, burnishing the surface, low plasticity burnishing the surface, and laser shock peening the surface, to plastically deform at least one of the substrate or the coating in the vicinity of the groove.

6. The manufacturing method of claim 1, wherein the coating comprises one or more of an outer structural coating layer, a bond coating and a thermal barrier coating.

7. The manufacturing method of claim 1, further comprising forming one or more grooves by machining into the outer surface of the substrate, forming one or more grooves by machining into the inner surface of the substrate and applying a structural coating over at least a portion of the outer surface of the substrate to define one or more channels in the outer surface of the substrate.

8. The manufacturing method of claim 7, further comprising applying a structural coating over at least a portion of the inner surface of the substrate to define one or more channels in the inner surface of the substrate.

9. The manufacturing method of claim 1, further comprising forming one or more grooves by machining into the coating layer disposed on the outer surface of the substrate, forming one or more grooves by machining into the coating layer disposed on the inner surface of the substrate and applying the structural coating over the coating layer on the outer surface of the substrate to define one or more channels on the outer surface of the substrate.

10. The manufacturing method of claim 9, further comprising applying a structural coating over one of the inner surface of the substrate or the coating layer disposed on the inner surface of the substrate to define one or more channels on the inner surface of the substrate.

11. A manufacturing method comprising:
providing a substrate with an inner surface, an outer surface and at least one interior space;
forming one or more grooves into the outer surface of the substrate or into a coating layer disposed on the outer surface of the substrate, wherein each groove extends at least partially along the outer surface;
forming one or more grooves into the inner surface of the substrate or into a coating layer disposed on the inner surface of the substrate, wherein each groove extends at least partially along the inner surface;
processing at least a portion of one of the outer surface of the substrate or the coating disposed on the outer surface of the substrate as to plastically deform and facet one of the outer surface of the substrate or an outer surface of the coating at least in a vicinity of the top of a respective groove, such that a gap across a top of the groove is reduced; and
applying a structural coating over one of at least a portion of the outer surface of the substrate or at least a portion of the coating layer disposed on the outer surface of the substrate,
wherein one or more cooling channels are defined one of into the inner surface of the substrate or into a coating layer disposed on the inner surface of the substrate and one or more cooling channels or cooling grooves are defined one of into the outer surface of the substrate or into a coating layer disposed on the outer surface of the substrate for cooling a component.

12. The manufacturing method of claim 11, wherein the step of forming one or more grooves into one of the outer surface of the substrate or the inner surface of the substrate further comprises forming at least a portion of the one or more grooves into a portion of the substrate.

13. The manufacturing method of claim 11, wherein processing at least a portion of one of the outer surface of the substrate or an outer surface of the coating disposed on the outer surface of the substrate comprises performing one or more of shot peening the surface, water jet peening the surface, flapper peening the surface, gravity peening the surface, ultrasonic peening the surface, burnishing the surface, low plasticity burnishing the surface, and laser shock peening the surface, so as to deform the surface at least in a vicinity of the top of a respective groove and facet the surface adjacent at least one edge of the groove.

14. The manufacturing method of claim 11, wherein the structural coating comprises one or more of an outer structural coating layer, a bond coating and a thermal barrier coating.

15. The manufacturing method of claim 11, further comprising applying a structural coating over one of at least a portion of the inner surface of the substrate or at least a portion of the coating layer disposed on the inner surface of the substrate to define one or more cooling channels one of into or on the inner surface of the substrate.

16. A component comprising
a substrate comprising an outer surface and an inner surface, wherein the inner surface defines at least one interior space;
one or more grooves formed into the outer surface of the substrate or into a coating layer disposed on the outer surface of the substrate, wherein each groove extends at least partially along the outer surface and has a base and an opening;
one or more grooves formed into the inner surface of the substrate or into a coating layer disposed on the inner surface of the substrate, wherein each groove extends at least partially along the inner surface to define one or more cooling grooves on an inner surface of the substrate and has a base and an opening; and
a structural coating disposed over one of at least a portion of the outer surface of the substrate or the coating disposed on the outer surface of the substrate to define one or more cooling channels on the outer surface of the substrate.

17. The component of claim 16, further comprising a structural coating disposed over one of at least a portion of the inner surface of the substrate or the coating disposed on the inner surface of the substrate to define one or more cooling channels on the inner surface of the substrate.

18. The component of claim 16, further comprising one or more cooling supply holes in fluid communication with the one or more cooling channels and one or more exit features in fluid communication with the one or more cooling channels.

19. The component of claim 16, wherein a plurality of surface irregularities are formed in the vicinity of a respective groove in at least one of the outer surface of the substrate, the inner surface of the substrate, the coating disposed on the outer surface of the substrate or the coating disposed on the inner surface of the substrate.

20. The component of claim 16, wherein the coating disposed on at least one of the outer surface of the substrate or the inner surface of the substrate comprises one or more of an outer structural coating layer, a bond coating and a thermal barrier coating.
